(19) United States
(12) Patent Application Publication
(10) Pub. No.: US 2006/0127151 A1
(43) Pub. Date: Jun. 15, 2006

(54) Process, a printing machine, and a toner for improving one characteristic of a printing medium and/or a printed format

(75) Inventors: Detlef Schulze-Hagenest, Molfsee (DE); Dinesh Tyagi, Fairport, NY (US); Udo Draeger, Speyer (DE)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/350,444

(22) Filed: Feb. 9, 2006

(30) Foreign Application Priority Data
Aug. 13, 2003 (DE) 103 37 160.5
Aug. 12, 2004 (WO) PCT/US04/26200

(51) Int. Cl. G03G 15/00

(52) U.S. Cl. 399/407

(57) ABSTRACT

At least one physical characteristic of a printed format on a printing medium and/or at least one physical characteristic of the printing medium is improved. At least one essentially colorless toner containing at least one substance that affects at least one physical characteristic, is applied to the printing medium and/or the printed format.

### FIELD OF THE INVENTION

The invention pertains to improving at least one physical characteristic of a printed format on a printing medium, preferably created by electrophotographic printing units.

### BACKGROUND OF THE INVENTION

In conventional electrophotographic color printing machines, a printing format, is produced by, overlaying different colored toner images upon each other. These toner images are transferred from electrophotographic printing units, either directly onto the printing medium upon which they are laid on each other, or onto a transfer medium that is located between the individual printing units and the printing medium, where they are then overlaid upon each other, and are then transferred from this transfer medium onto the printing medium in a single step. The toner is subsequently fused onto the printing medium in a fuser mechanism.

Generally, the toner is fused onto the printing medium through the affects of pressure and heat, applied with a fuser roller and an impression device. It is possible however, for the toner to be fused onto the printing medium in a contact-free method, for example, in a microwave fuser mechanism.

Often, sheet paper or rolled sheets are used as the printing medium. The use of foils or other materials, however, is equally conceivable.

It is often preferred that the optical characteristics of various image areas of a printed format contain different finishes. For example, image areas that contain only text should have a duller gloss than image areas that contain pictorial elements. The duller text is then easier to read. With respect to image areas containing pictorial elements, it is more likely that a higher gloss will be desired.

In color printing machines, a toner that has a high gloss value is used for the black colors, in order to achieve a uniform gloss, at least with respect to the image areas containing pictorial elements. With this method, the desired low gloss in the areas containing text is not achieved. Based upon the categorization pertaining to the CMYK colors, the toner for the black colors can be referred to as K toner.

In U.S. Pat. No. 5,506,671, in addition to the already available electrophotographic printing units of a color printing machine, for example, those needed for the toner in the CMYK colors, in order to improve the optical appearance of print media, it is proposed that an additional printing unit be made available for applying a colorless toner to the printed format. This colorless toner is then able to either raise or lower the medium's glossiness of image areas containing pictorial elements. The colorless toner can be applied to the entire printing medium, where it will influence the glossiness. It can also protect the printed format from UV radiation or mechanical stresses.

### SUMMARY OF THE INVENTION

The objective of the subject invention is a process and printing machine, in which at least one physical characteristic of a printed format on a printing medium and/or at least one physical characteristic of a printing medium is improved.

The objective of the invention is achieved by at least one essentially colorless toner containing, at least one substance that affects at least one physical characteristic, being applied to the printing medium and/or the printed format. The objective of the invention is further achieved through the use of an ink according to the invention, that contains at least one substance affecting at least one physical characteristic of a printed format and/or a printing medium. The ink particularly may be essentially colorless. In the following, we can simply refer to a colorless ink. This term should encompass, in particular, an essentially, colorless ink.

The printing medium and/or the printed format that has already been created, preferably by electrophotographic printing units in the printing machine, can be imprinted with the colorless ink through use of a printing machine according to the invention that contains at least one ink jet mechanism.

The ink can be constructed so that it can be dried by a downstream heat source. Provision can also be made for it to be constructed so that it dries while being absorbed into the printing medium, so that no smearing can occur.

If the colorless ink is applied to the entire printing medium, the application will beneficially protect the printing medium from physical stresses.

In a beneficial type of process, provision is made for the colorless ink to be applied to areas of the printing medium and/or the printed format with a gloss value that is to be raised. To achieve this purpose, a colorless ink, that contains gloss, generating polymers is then beneficially used, according to the invention. These polymers can be co-polymers. Specifically, they can be plug polymers made of ethylene-like, unsaturated monomers.

Accordingly, an ink that increases the gloss value as is described in U.S. Pat. No. 6,117,921, can be created. This ink can then be selectively applied to the areas of the printing medium and/or to the printed format whose glossiness is to be increased. It is possible specifically to selectively increase the glossiness of dull printing media.

In a beneficial process, provision is made for applying the colorless ink to areas of the printing medium and/or to the printed format where resistance to UV radiation is to be raised. To achieve this purpose, a colorless ink is used containing substances that absorb UV radiation. Thus, the printed format on the printing medium becomes better protected from sun rays and does not pale as quickly. The printed format remains colorfast for a longer period of time.

To achieve this purpose, a colorless ink according to the invention is used in which the added substance contains dulling components, preferably Sio₂ or TiO₂. The substances in the ink should not exceed a certain maximum concentration so that the colorless ink can continue to be essentially translucent. Accordingly, desired areas of a printed format can easily be given a duller finish, through the application of colorless ink to such areas.

In an additional beneficial embodiment, provision is made for the smell of the printed format or the printing medium to be affected by the colorless ink. To achieve this purpose, the use of a colorless ink containing aromatic substances is proposed. The olfactory impression created by the printing mechanism can be beneficially influenced. For example, aromatic substances can be added to the ink so that the printed product smells like cardamom and/or cinnamon, aromas that would be particularly desirable during the Christmas season.

In another alternative process, provision is beneficially made for the colorless ink to be applied to areas of the printing medium and/or the printed format that are to contain special colors. To achieve this purpose, a still, colorless ink according to the invention, is used in which the added substances are tinting components. Such tinting components can be metals, resins, color pigments, or the like, with which special colors can be created. Such special colors can then be easily transferred onto selected areas of the printing medium and/or the printed format.

In another beneficial embodiment of the ink, provision is made for the ink to contain at least one substance that incorporates natural and/or pseudo-natural dyes. This ink can then be beneficially applied to packaging materials in order to protect the packaged product from light impinging on the packaging material, for example. The concentration of the natural and/or pseudo-natural dyes can be selected so that the ink essentially appears to be colorless.

In a particularly beneficial further development, provision is made for the natural and/or pseudo-natural dyes to display absorption properties that are similar to those of a product that is at least partially covered by a packaging material that has been imprinted with the ink. This packaging material can then selectively absorb light with wavelengths that would otherwise cause undesirable aging of the product. At the same time, beneficially, it is possible for the packaged product to continue to be easily visible through the packaging. The use of such packing materials removes the necessity for the product's packaging to be completely opaque. Thus, a consumer is able to see the product through the packaging and to determine its quality, while the quality of the product is simultaneously prevented from being adversely affected by the light that impinges on the packaging. The packaged product can, for example, be foodstuff, cosmetics, or pharmaceuticals.

Concerning certain functions, provisions can be made for all or some of the listed substances to be added to, an essentially colorless ink. The essentially colorless ink can also contain water and/or solvents, which however, must not significantly affect the chromaticity of the ink.

In a particularly beneficial embodiment, provision is made for the use of colorless, hot-melt ink. This colorless ink should pass into the liquid state at a temperature in the range of 50° C. to 120° C., but preferably in the range of 80° C. to 105° C., and should be in the solid state below such range. A Piezo ink jet head operates in this preferred temperature range. Thus, the colorless ink is available in a liquid state and can therefore be easily applied to the printing medium using the ink jet head. The colorless ink can then be selectively applied to certain areas of the printed format or the printing medium. Accordingly, so-called “spot painting” can be easily accomplished, for example. The data concerning the locations where the ink is to be applied can be gathered from the print job, but can also be manually inserted.

When using the colorless ink, it is particularly easy to vary the amount of ink that is applied and thus to create different levels of glossiness in different places, for example.

In a beneficial embodiment, provision is made for the ink to be applied to a printed format that has already been fused onto the printing medium. With this method, the ink is not affected by the fusing event.

In a further embodiment according to the invention, provision is made for the colorless ink to be applied to a printed format that has already been fused to a printing medium with the use of a fuser roller.

The goal of the invention is further achieved through the use of a printing machine that incorporates at least one ink jet mechanism for applying an essentially colorless ink that contains at least one substance that affects at least one physical characteristic to a printing medium and/or a printed format.

Consequently, the process according to the invention can be implemented.

In an additional development of the printing machine according to the invention, provision is made for the ink jet mechanism to be located downstream of a fuser mechanism that incorporates a fuser roller with respect to the direction of conveyance of the printing medium. Accordingly, the colorless ink can be applied after the other toner images have been fused to the printing medium. Consequently, as the ink does not come into contact with a fuser roller, resulting in no residual ink adhering to the fuser roller.

In another alternative embodiment of the printing machine, provision is made for the ink jet mechanism to be located upstream of a fuser mechanism that operates in a contact-free method. Such a contact-free fuser mechanism can be, for example, a microwave fuser mechanism.

In an additional beneficial embodiment, provision is made for the minimal single ink jet mechanism to be located in at least one separate print module. Accordingly, a conventional printing machine can be easily expanded with such an ink jet mechanism and thus be transformed into a printing machine in accordance with the invention.

It is also possible to simply place two or more such print modules one behind the other, and to allocate the number of ink jet mechanisms to correspond to individual needs. This alignment, whereby the ink jet mechanism is in a printing module, is particularly beneficial when the remaining toner images are fused onto the printing medium through a fuser mechanism that incorporates a fuser roller. The corresponding printing module containing the ink jet mechanism can be conveniently placed downstream of the fuser mechanism.

It is also possible, specifically, for such a printing module to be located upstream of the, electrophotographic printing units of the printing machine, for example. With this location of a printing module, a decorative color such as white, for example, can be selectively applied in advance to specific areas of the printing medium.

The invention, and its objects and advantages, will become more apparent in the detailed description of the preferred embodiments presented below.

### BRIEF DESCRIPTION OF THE DRAWINGS

Embodiments of a process and of a printing machine according to the invention, for improving at least one physical characteristic of a printed format on a printing medium that has been created, preferably by electrophotographic printing units from which additional inventive characteristics can be derived, but to which the scope of the invention is not limited, are shown in the following drawings in which:

5 FIG. 1 shows a printing machine containing an ink jet mechanism and a fuser mechanism that incorporates a fuser roller;

FIG. 2 shows a printed format containing various image areas;

FIG. 3 shows an alternative configuration of a printing machine containing an ink jet mechanism and a fuser mechanism that incorporates a fuser roller;

FIG. 4 shows an additional printing machine containing two ink jet mechanisms and a contact-free fuser mechanism; and

FIG. 5 shows an additional printing machine containing a modular configuration of ink jet mechanisms.

### DETAILED DESCRIPTION OF THE INVENTION

Referring now to the accompanying drawings, FIG. 1 shows a basic configuration of a printing machine 1. As shown here, the printing machine 1 consists of four electrophotographic printing units 2 through 5. They are assembled here collectively, in one printing mechanism 6.

For the purposes of the invention, the number of printing units that are contained in the printing mechanism 6 is without significance. It is possible for the printing mechanism to include one electrophotographic printing unit or more than four printing units. It is also possible for the printing units contained in the printing mechanism 6 to be other types of electrophotographic units.

The printing units 2 through 5, controlled by any switchable printing machine control transfer toner images in the CMYK colors onto a sheet of paper 7, but an alternative-printing medium can be used. To achieve this purpose, the sheet of paper 7 is conveyed in the direction of the arrow 8 through the printing machine 1 along a travel path 9.

After the toner has been transferred in the printing mechanism 6, the sheet of paper 7 is further conveyed through an ink jet mechanism 10.

Depending on the colorless ink 11 that is used in this ink jet mechanism 10 and the effects that are to be achieved by the ink, the colorless ink 11 is transferred onto the entire surface of the sheet of paper 7, or only onto selected areas thereof.

The necessary data for printing machine control for a selective transfer of the colorless ink 11 from the ink jet mechanism 10 onto the sheet of paper 7 are taken from a data set that is based on the print job. In addition, the selected areas can be manually inputted before the print job is fed into the printing machine and thus added to the data for the print job.

In the foregoing, the only ink discussed is colorless ink, therefore, the adjective “colorless” will no longer be used in the current discussion. The term “ink” is hereinafter used to describe essentially colorless ink, according to the invention.

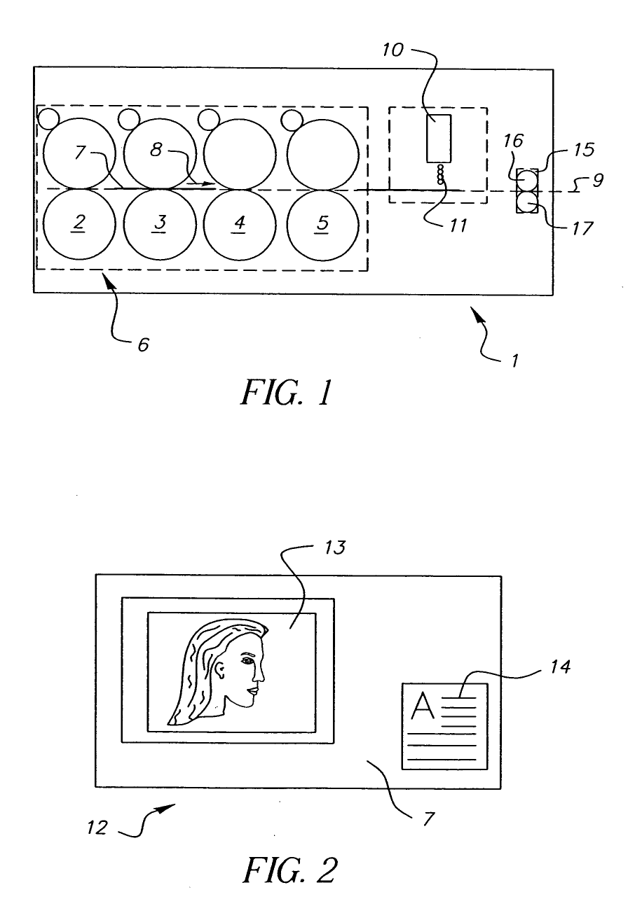

In the process presented here, a printed format 12, as shown in FIG. 2, is transferred onto the paper sheet 7 by the printing mechanism 6. In this printed format 12, various image areas 13 and 14 can be distinguished. The image area 13 contains pictorial elements and the image area 14 solely contains textual elements.

In the image area 14 a dull appearance is desired for the image and for the image area 13, a glossier appearance is desired for the image. Consequently, in using a dull K toner, a black, dull toner image is created on the sheet of paper 7 in the printing mechanism 6. Thus, the requirements for a dull appearance in the image area 14 are met.

In order to achieve a high gloss in the image area containing pictorial elements, CMY toner with a high gloss value is used. An uneven gloss results in creating the image area 13, since the dull K toner is also used. The data concerning the locations in the printed format 12 where K toner is present in image area 13, is gathered from the print data in the print machine control.

The ink 11 for the ink jet mechanism 10 contains substances that increase its glossiness. Based on the print data received by the print machine control, ink 11 is now transferred by the ink jet mechanism 10 to the locations in image area 13 where K toner is present. Accordingly, the glossiness of that area can be increased and ultimately matched to the gloss value of the CMY toner. Alternatively, the entire image area 13 can be coated with the proper amount of ink 11 in order to easily create a uniformly high level of glossiness.

After the ink I 1 has been applied to the sheet of paper 7, the sheet of paper 7 is further conveyed through a fuser mechanism 15. Here, the fuser mechanism is mainly a fuser roller 16 and a compression roller 17 that combine to fuse the toner and the ink onto the sheet of paper 7 through heat and pressure.

Alternatively, or additionally, other substances can be added to the ink 11, for example, for the purpose of improving the UV resistance of selected areas or the entire area of the sheet of paper 7. Additionally, wear and tear of the sheet of paper 7 caused by stresses can be reduced through the use of a suitable protective layer of the ink 11.

A packaging material, not depicted in the drawing, can also be imprinted by the ink 11, for example. This packaging material can then be used to package products such as foodstuffs, cosmetics, or pharmaceuticals. To achieve this purpose of imprinting the packaging material, the ink 1 1 can contain natural and/or pseudo-natural dyes that absorb light with the same wavelengths as those that the packaged product would also absorb. Specifically, the dyes contained in the ink 11 can be the same as or similar to the dyes contained in the product.

Until now these products were consistently packaged in opaque packaging materials in order to prevent their quality from being adversely affected by irradiation with light. The products often deteriorate as they absorb light rays. The packaging material can now be translucent and the ink can be essentially colorless. The natural and/or pseudo natural dyes that are added should be present in the packaging material in such concentration as to not significantly adversely affect the colorlessness of the ink. A person, such as a consumer in a store, can thus discern and evaluate the product inside the packaging, while the light of a wavelength that would otherwise be absorbed by the packaged product is not absorbed by the product. The light is instead absorbed by the dye contained in the ink 11.

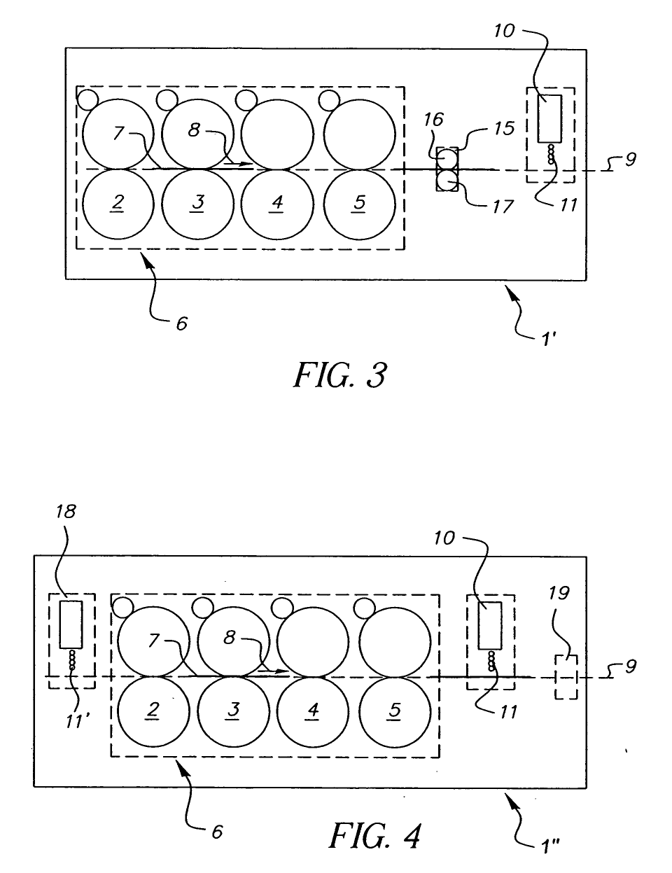

FIG. 3 shows an alternative configuration of a printing machine 1′ that contains an ink jet mechanism 10 and a contact-making fuser mechanism 15. The ink jet mechanism 10 as shown in FIG. 3 is located downstream of the fuser mechanism 15 as opposed to the configuration of the printing machine 1 as shown in FIG. 1. Thus, the ink 11 does not pass through the fuser mechanism 15 and the danger of allowing residual ink in the fuser mechanism 15 is avoided. The ink 11 dries on the sheet of paper 7 when it cools off.

The ink 11 is applied to the sheet of paper 7 in an ink jet mechanism 10 by a piezo mechanism. The operating temperature of the piezo mechanism is in the range of 80° C. to 105° C. The ink 11 that is used here, is based on a hot melt ink, that becomes liquefied in this temperature range and can thus be applied to the sheet of paper 7. When cooled below 80° C., the ink 11 sublimates so that it dries solidly, it can no longer be smeared, and it can protect the sheet of paper 7 or a printed format 12 on the sheet of paper 7.

FIG. 4 shows an alternative printing machine 1″ that contains two ink jet mechanisms 10 and 18, and a contact-free fuser mechanism 19. The same numbers are used to identify identical components in this drawing that were used in the previous drawings.

As opposed to the printing machine 1 shown in FIG. 1, the printing machine 1″ shown in FIG. 4 essentially incorporates an additional ink jet mechanism 18 that is located upstream of the printing mechanism 6, and a contact-free fuser mechanism 19 is used here as the fuser mechanism. This fuser mechanism 19 can fuse the toner onto the sheet of paper 7 by infrared radiation, for example. However, in the printing machine 1″ that is shown here, the toner is fused onto the sheet of paper 7 through microwave radiation.

The additional, upstream ink jet mechanism 18 can be used in the printing machine I to apply an additional colorless toner 11′ to the sheet of paper 7. Additionally, this toner 11′ can contain special colors or other substances. In the present case, the toner 11′ should contain white dye. This allows for different colored sheets of paper 7 to be used as the printing medium, or for the use of other colored printing media. Certain areas of the sheet of paper 7, such as areas that will later be written on, can then be imprinted in white, so that the text is easier to read.

The printing process used in this printing machine is basically the same as that used in the printing machine 1, shown in FIG. 1, until the point where the colorless toner 11 is applied by the ink jet mechanism 10. Following the ink jet mechanism 10 the toner is fused onto the sheet of paper 7 and the ink 11 and 11′ is dried. To achieve this purpose, the sheet of paper 7 is conveyed through a fuser mechanism 19, just as in the case with the printing machine 1. This fuser mechanism 19, specifically, is a microwave fuser mechanism that fuses the toner onto the surface of the sheet of paper 7 without making any contact. As opposed to the situation that exists when a contact-making fuser mechanism 15 is used, as shown in FIG. 1, no ink will stick to a fuser roller 16 and no residual ink will remain in the fuser mechanism 19.

Under control of the printing machine control, so-called “spot painting” can be performed on the sheet of paper 7 with the paint 11 already described with respect to FIGS. 1 and 2. Image areas 14 containing only text are consequently left dull, while the gloss in image areas 13 that contain pictorial elements is increased through an ink 11, with the appropriate gloss value. Alternatively, provision is made to achieve a uniform glossiness in the image area 13.

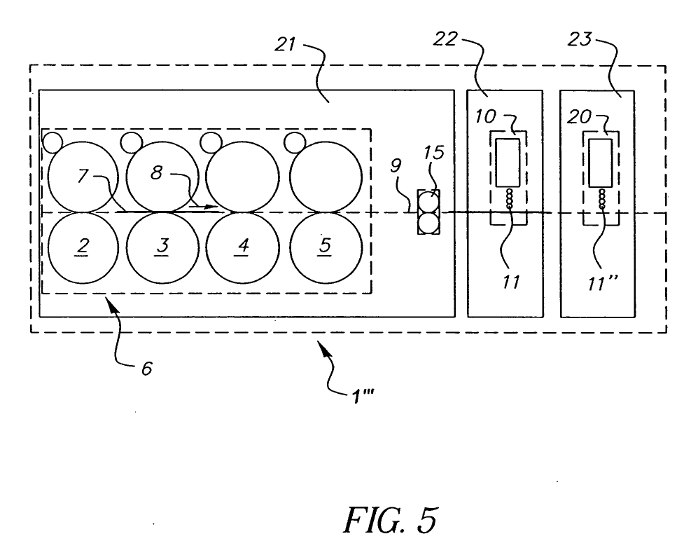

FIG. 5 shows another configuration of an alternative printing machine 1′″. This printing machine 1′″ is constructed modularly. The printing mechanism 6 and the fuser mechanism 15 are combined in this depiction in a printing module 21. With reference to the direction of travel of the sheet of paper 7, two ink jet mechanisms 10 and 20 are positioned downstream of the fuser mechanism 15. The two ink jet mechanisms 10 and 20 are each located individually in printing modules 22 and 23.

Here, the fuser mechanism 15 is the same fuser mechanism shown in FIG. 1. It fuses the toner to the sheet of paper 7 using a fuser roller 16 and a compression roller 17 to make contact with the sheet of paper 7. After the toner has been applied to the sheet of paper 7 in the printing module 21 and has been fused, the ink 11 is applied in the printing module 22 to selected image areas 13, so that “spot-painting” occurs in that area. After the “spot painting”, the sheet of paper 7 passes through the printing module 23, where it is imprinted with a colorless ink 11″. This ink 11″, can also contain different substances. Here, it contains UV light absorbing substances and it is applied across the entire sheet of paper 7, resulting in protection for the entire ink format 12 from the adverse effects of sun rays.

The colorless inks 11 and 11″ can then dry in the air. Since so-called “hot-melt” inks are used here, a separate drying mechanism is not necessary. The inks 11 and 11″ are applied to the sheet of paper 7 via piezo technology. The operating temperature of the piezo mechanism is sufficiently high for the inks 11 and 11″ to be available in their liquid state. Once the inks 11 and 11″ have been applied to the sheet of paper, their temperature decreases so that they rapidly cool below melting or to solidifying temperature and become solid. The dried inks, 11 and 11″, can no longer be smeared. They protect the sheet of paper 7, so that the printed format 12 and the sheet of paper 7 can subsequently be handled and stacked without limitation.

The modular construction of the printing machine 1′″ can be such that an existing printing machine can serve as the printing module 21, while the other printing modules 22 and 23 are positioned downstream thereof. If desired, additional printing modules or a single printing module containing ink jet mechanisms can be used, whereby printing modules can also be positioned upstream of the printing mechanism 6 that incorporates printing module 21.

In the various methods presented, and in variations thereof, it is possible to apply essentially colorless inks 11 and 11″, etc. to a sheet of paper 7 or to a printed format 12, or selectively, to pre-selected image areas 13 and 14 of the printed format 12. Such colorless ink 11 can be applied either upstream or downstream of a fuser mechanism 15 or 19. If a contact-making fuser mechanism 15 is used, the ink 1 1 should preferably be applied after the toner has been fused onto the sheet of paper 7, so that no residual ink remains on the fuser roller.

If a contact-making fuser mechanism 19 is used, it is preferable to position the ink jet mechanism 10 upstream of the fuser mechanism 19. Based on the construction of the fuser mechanism 19, it is possible for misalignments of the sheet of paper 7 to occur inside the fuser mechanism 19. If the ink 11 is applied to the sheet of paper 7 upstream of the fuser mechanism 19, the ink 11 can be more precisely positioned on the sheet of paper 7 and the printed format 12. Since the fusing is accomplished here without any contact, no concern that residual ink will remain in the fuser mechanism 19 arises.

In addition, it is possible for ink jet mechanisms 10 and 20, etc. to be located upstream of the printing mechanism 6 in the printing machine 1, 1′, 1″, 1′″, etc. These ink jet mechanisms 10 and 20, etc. can therefore precisely apply the ink 11, which may be mixed with white coating, for example, to the sheet of paper 7, so that toner can subsequently be applied thereto.

In addition, one more modular configuration of the printing machine 1′″ is possible. In such a configuration, the printing machine 1′″ may be assembled more modularly. Specifically, it would be convenient to transform an already existing printing machine that contains a printing mechanism 6 and a fuser mechanism 15 or 19 into a printing machine 1′″, according to the invention.

1. A process for improving at least one physical characteristic of a printed format on a printing medium that is preferably created by electrophotographic printing units, characterized by said printing medium and/or said printed format (12) is imprinted with an essentially colorless ink (11 and 11′), that contains at least one substance that influences at least one physical characteristic.

2. A process according to claim 1, characterized by said fact that said colorless ink (11 and 11′) being applied to areas of said printing medium with levels of glossiness that is to be raised.

3. A process according to claim 1, characterized by colorless ink (11 and 11′) being applied to areas of said printing medium and/or said printed format with UV resistance to be raised.

4. A process according to claim 1, characterized by said colorless ink (11 and 11′) being applied to areas of said printing medium and/or said printed format to be made dull.

5. A process according to claim 1, characterized by said smell of said printed format or of said printing medium being influenced by said colorless ink (11 and 11′).

6. A process according to claim 1, characterized by said colorless ink (11 and 11′) being applied to areas of said printing medium and/or said printed format that have special colors.

7. A process according to claim 1, characterized by a hot melt ink being used as said colorless ink (11 and 11′).

8. A process according to claim 1, characterized by said colorless ink (11 and 11′) being applied to a printed format that has already been fused onto a printing medium.

9. A process according to claim 8, characterized by said colorless link (11 and 11′) being applied to a printed format (12) that has already been fused onto a printing medium by a fuser roller (16).

10. An electrophotographically operating printing machine, characterized by at least one ink jet mechanism (10, 18, and 20) for applying an essentially colorless ink (11 and 11′) that contains at least one substance that influences at least one physical characteristic to a printing medium and/or a printed format (12).

11. A printing machine according to claim 10, characterized by said ink jet mechanism (10, 18, and 20) being located downstream, with reference to said printing medium's direction of travel, of a fuser mechanism (15) that incorporates a fuser roller (16).

12. A printing machine according to claim 10, characterized by said ink jet mechanism (10, 18, and 20) being located upstream, with reference to said printing medium's direction of travel, of a fuser mechanism (19) that fuses without making contact.

13. A printing machine according to claim 10, characterized by said at least one ink jet mechanism (19, 18, and 20) being located in at least one separate printing module (22 and 23).

14. An ink, for use in said printing machine, characterized by at least one substance that influences at least one physical characteristic of a printed format and/or a printing medium.

15. An ink according to claim 14, characterized by said substance being gloss-generating polymers.

16. An ink according to claim 14, characterized by said substance absorbing UV rays.

17. An ink according to claim 14, characterized by said substance incorporating dulling components, such as SiO₂ or TiO_{2.}

18. An ink according to claim 14, characterized by said substance incorporating aromatic materials.

19. An ink according to claim 14, characterized by said substance containing tinting components.

20. An ink according to claim 14, characterized by said substance containing natural and/or pseudo-natural dyes.

21. An ink according to claim 20, characterized by said dyes having absorption properties that are at least similar to those of a product that is to be at least partially enclosed in a packaging material that is imprinted with the ink.
